(19) United States
(12) Patent Application Publication
(10) Pub. No.: US 2014/0326934 A1
(43) Pub. Date: Nov. 6, 2014

(54) RAPID LIFT FLOOR JACK

(71) Applicant: HangZhou TianHeng Machinery Co., Ltd., HangZhou (CN)

(72) Inventors: HaoLiang Zhou, LinAn City (CN); ZhengWei Gong, HangZhou (CN)

(21) Appl. No.: 13/925,120

(22) Filed: Jun. 24, 2013

(30) Foreign Application Priority Data
May 5, 2013 (CN) 201310164029.9

(51) Int. Cl. B66F 5/04

(52) U.S. Cl. CPC B66F 5/04
USPC 254/2 B

(57) ABSTRACT

A linkage for a lifting device having a body, a lift arm pivotally attached to the body at a first pivot point and an actuator, includes a power arm pivotally attached to the body at a second pivot point. The power arm is also pivotally connected to the actuator at a third pivot point spaced at a first distance from the second pivot point. A connecting arm has a proximate end pivotally attached to the power arm and a distal end pivotally attached to the lift arm. The proximate end of the connecting arm is preferably connected to the power arm at a fourth pivot point which is spaced at a second distance from the second pivot point wherein the second distance is greater than the first distance, however the proximate end of the connecting arm can alternatively be connected to the power arm at the third pivot point.

### CROSS-REFERENCE TO RELATED APPLICATIONS

This application claims priority from Chinese application No. 201310164029.9 filed May 5, 2013, the contents of which are incorporated herein by this reference.

### BACKGROUND OF THE INVENTION

1. Field of the Invention

This invention is related to lifting equipment and more specifically to a hydraulic floor jack having an internal linkage which allows for more rapid lifting than conventional floor jacks.

2. Description of the Related Art

Floor jacks are well known in the prior art and are frequently used in automotive service to lift a vehicle in order to provide access to the underside of the vehicle or to lift one or more tires off of the floor for service. They may also be used to lift other objects. Floor jacks typically include a body supported on wheels and are operated by a hydraulic pump/actuator assembly having a manually operated hydraulic pump paired with a hydraulic actuator. The pump is operated by means of a handle which is pumped up and down to produce hydraulic pressure. The actuator portion of the hydraulic assembly includes an actuator rod which extends in response to building hydraulic pressure in the pump. The typical floor jack includes a lift arm which is pivotally connected to the body at a first pivot point near its proximate end. A distal end of the actuator rod is pivotally connected to the lift arm at a second pivot point offset from the first pivot point but still positioned adjacent to the proximate end of the lift arm. A distal end of the lift arm is connected to a saddle having an abutment surface for engaging the underside of an object to be raised. A pair of stabilizer links form a parallelogram linkage with the lift arm and act to keep the abutment surface of the saddle in a generally horizontal orientation throughout the range of movement of the lift arm.

As the pump handle is moved up and down, the actuator rod extends and the lift arm is pivoted about the first pivot point, causing the distal end of the lift arm and the attached saddle to move upwardly. If the jack is placed under an object to be lifted, and the handle pumped, the motion of the lift arm will bring the abutment surface into contact with the underside of the object to be raised and will eventually raise the object.

A problem with the typical floor jack is that the amount of pumping required to move the lift arm through its range of operation while lifting a load can be excessive. Many jacks require 30 or more cycles of the pump handle to bring the jack to its maximum height when lifting a rated load. What is desired is a floor jack that can be raised with fewer cycles of the pump handle, thereby lifting the load faster and easier.

Others addressing this problem have typically tried to modify the pump/actuator assembly in order to make the jack lift faster, either by installing a larger pump to move more hydraulic fluid on each stroke of the handle or by decreasing the bore of the actuator piston such that it takes less hydraulic fluid to make the actuator rod extend. U.S. Pat. No. 5,755,099 shows a hydraulic actuator assembly for a jack having a cylinder within a cylinder design which allows the jack to lift quickly under no-load or light load conditions, but which does not change the performance of the jack under heavy load. Making modifications to the pump/actuator assembly can be fairly expensive and has not always proven successful in solving the problem. It would be preferable to make the jack operate faster under load while retaining the standard pump/actuator assembly.

### SUMMARY OF THE INVENTION

The present invention includes an improved linkage for a lifting device, such as a floor jack, which connects the actuator rod of the hydraulic pump/actuator assembly to the lift arm and acts to make the lift arm move further on each stroke of the pump. The improved linkage includes a “power arm” which is pivotally attached to the body. The actuator rod is pivotally attached to the power arm at a point which is offset a first distance from the point where the power arm is connected to the body. A connecting arm has a proximate end pivotally attached to the power arm and a distal end pivotally attached to the lift arm. The proximate end of the connecting arm is preferably connected to the power arm at a point which is spaced at a second distance from the point where the power arm is connected to the body, the second distance being greater than the first distance. In an alternative embodiment, however, the proximate end of the connecting arm can be connected to the power arm at the same point as the actuator rod. The distance between the point where the distal end of the connecting arm connects to the lift arm and the point where the lift arm connects to the body should be at least one half (and preferably at least two thirds) of the distance between the point where the lift arm connects to the body and the point where the saddle connects to the lift arm, and should be longer than the distance between the point where the power arm connects to the body and the point where the proximate end of the connecting arm connects to the power arm.

### BRIEF DESCRIPTION OF THE DRAWINGS

FIG. 1 is a partially schematic cross-sectional view of a typical prior art jack in a raised position.

FIG. 2 is a view similar to FIG. 1 showing the prior art jack in a lowered position.

FIG. 3 is a perspective view of a rapid lift jack according to the present invention shown in a raised position.

FIG. 4 is a cross-sectional view of the rapid lift jack taken generally along line 4-4 in FIG. 3.

FIG. 5 is a view similar to FIG. 4 showing the rapid lift jack in a lowered position.

FIG. 6 is a top plan view of the rapid lift jack;

FIG. 7 is a bottom plan view of the rapid lift jack; and

FIG. 8 is a partially schematic cross-sectional view of an alternative embodiment of the rapid lift jack with a stabilizer arm removed for clarity.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

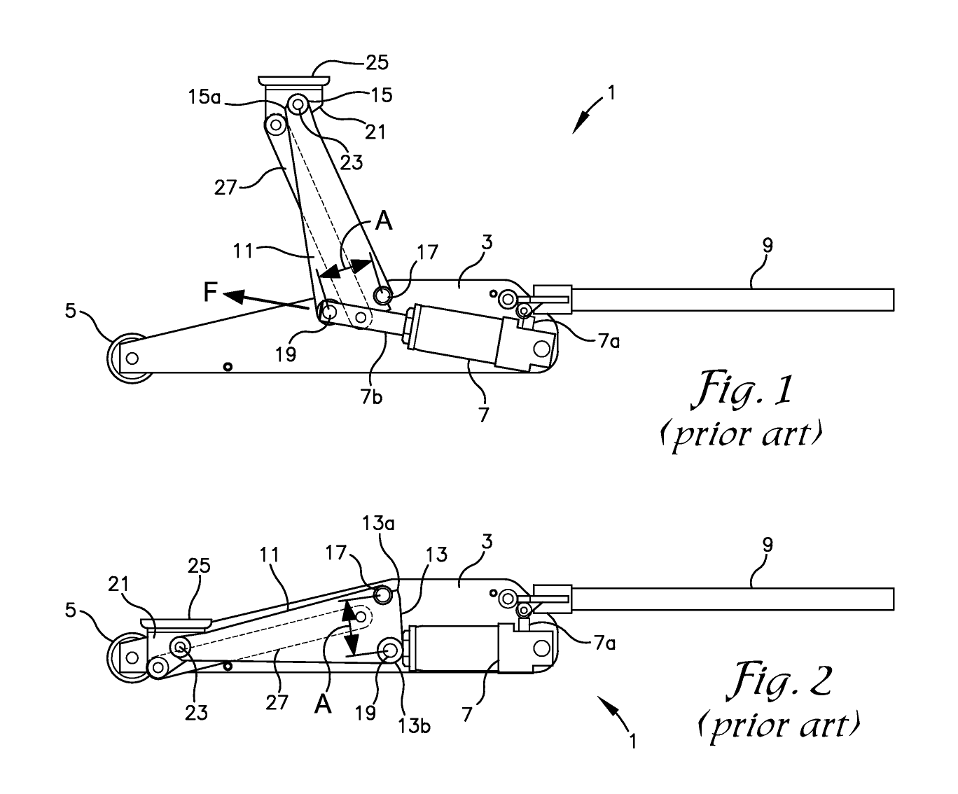

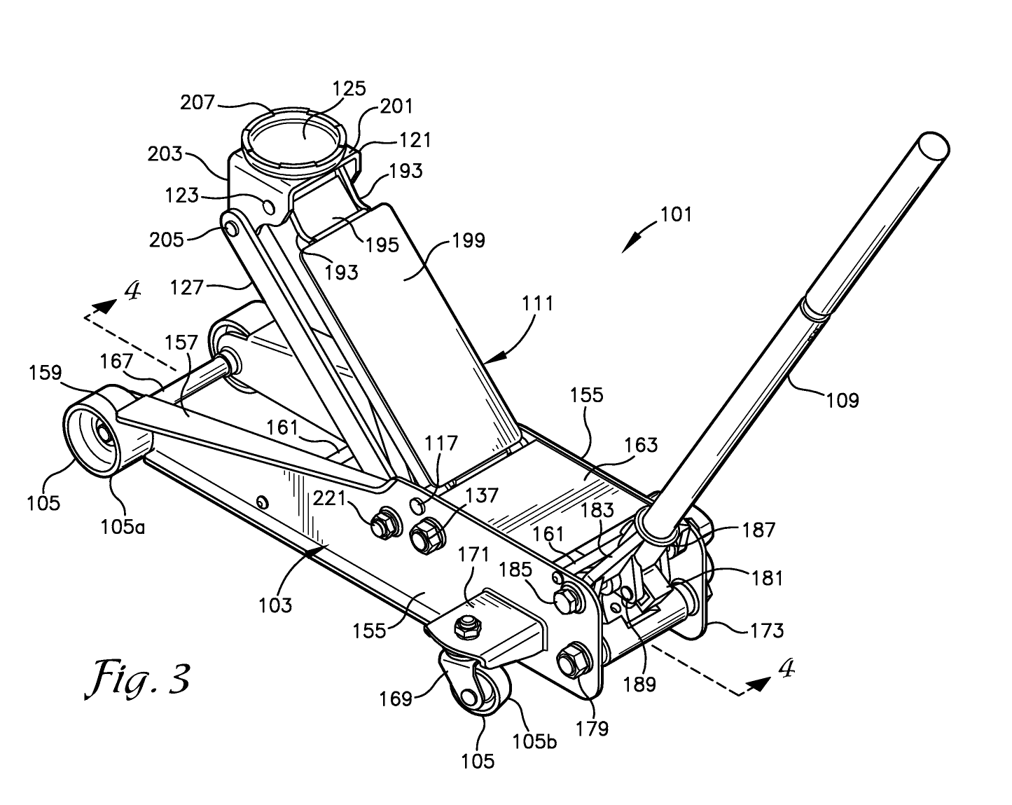

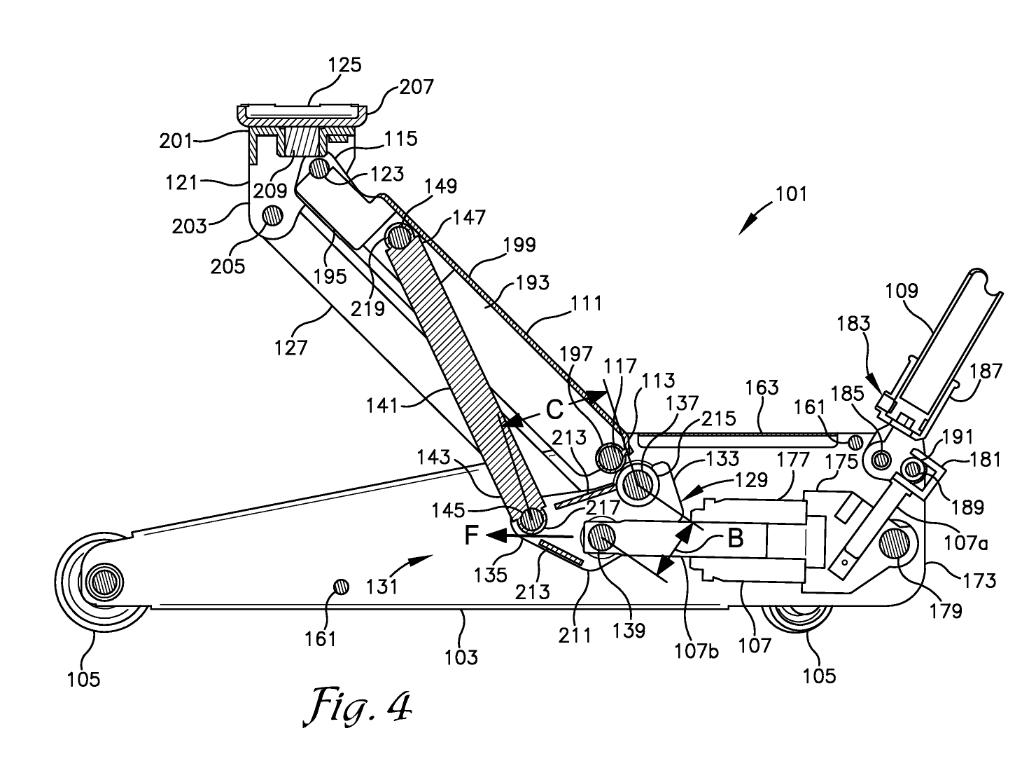

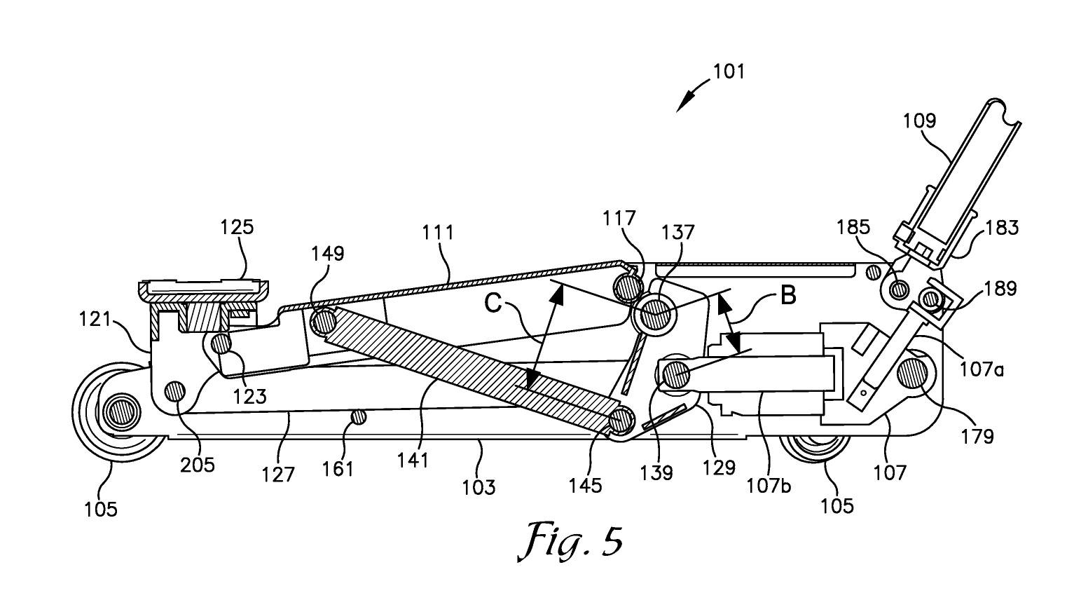

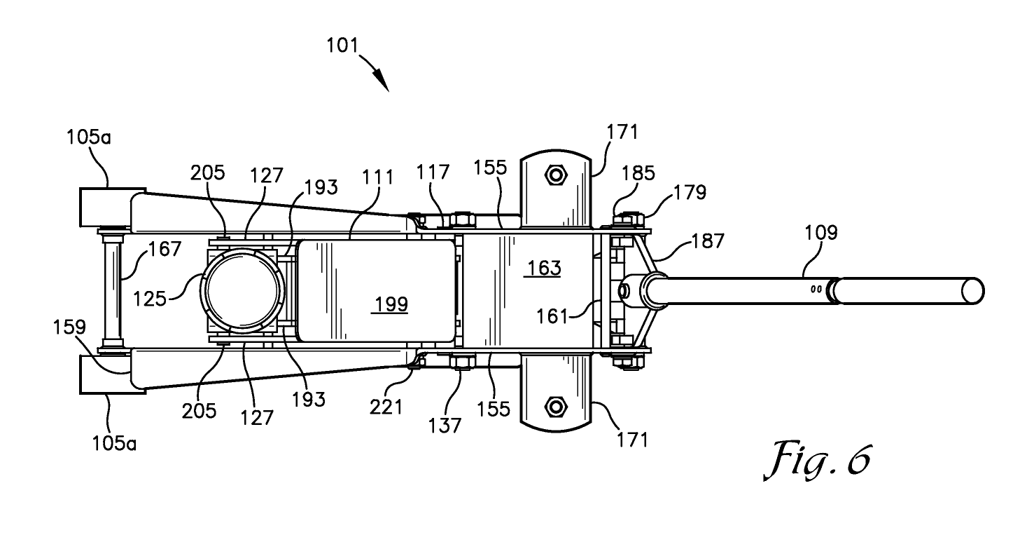

Referring to the drawings in more detail, FIGS. 1 and 2 show a typical prior art floor jack 1. A rapid lift floor jack 101 according to the present invention is shown in FIGS. 3-7. For purposes of comparison, the prior art floor jack 1 will be briefly described before turning our attention to the rapid lift floor jack 101. The jack 1 includes a body 3 supported on wheels 5. The body 3 houses a hydraulic pump/actuator assembly 7 having a pump rod 7a operatively engaged by a handle 9 and an actuator rod 7b. Manual pumping of the handle 9 cycles the pump rod 7a and produces hydraulic pressure which causes the actuator rod 7b to extend. The prior art floor jack 1 further includes a generally triangular shaped lift arm 11 having a proximate end 13 with an upper proximate vertex 13a and a lower proximate vertex 13b (see FIG. 2). A distal end 15 of the lift arm 11 is defined by a distal vertex 15a. The lift arm 11 is pivotally connected to the body 3 by a first pivot pin 17 located adjacent to the upper proximate vertex 13a. A distal end of the actuator rod 7b is pivotally connected to the lift arm 11 by a second pivot pin 19 positioned adjacent to the lower proximate vertex 13b. The pivot pins 17 and 19 each have a respective central axis and the two central axes are separated by a distance A.

A saddle 21 is pivotally connected to the distal end 15 of the lift arm 11 by a pivot pin 23 extending through the lift arm 11 proximate the distal vertex 15a. The saddle 21 includes an abutment surface 25 for engaging the underside of an object to be raised, such as a vehicle or component of a vehicle. A pair of stabilizer links or arms 27 each have a first end pivotally connected to the saddle 21 and a second end pivotally connected to the body 3. The stabilizer links 27 form a parallelogram linkage with the lift arm 11 and act to keep the abutment surface 25 of the saddle 21 in a generally horizontal orientation throughout the range of movement of the lift arm 11.

In use, the prior art jack 1 is rolled under the object to be raised and the abutment surface 25 is aligned with any suitable structure on the underside of the object for receiving an upward force to lift the object. A human operator begins pumping the handle 9 up and down, causing a pump portion of the hydraulic pump/actuator assembly 7 to build hydraulic pressure. As pressure builds, the actuator rod 7b begins to extend and applies a force F to the lift arm 11 trough the second pivot pin 19. Since the lift arm 11 is connected to the body 3 by the first pivot pin 17, the force F creates a torque acting on the lift arm 11 through a moment arm defined by the distance A between the first pivot pin 17 and the second pivot pin 19. The torque causes the lift arm 11 to begin to rotate upwardly, which in turn moves the saddle 21 upwardly. As the user continues to pump the handle 9, the lift arm 11 continues to move upwardly and eventually brings the abutment surface 25 into contact with the underside of the object to be raised. Continued pumping of the handle 9 after contact of the abutment surface 25 with the object will begin to raise the object.

Referring to FIGS. 3-7, the reference number 101 generally designates a rapid lift floor jack according to the present invention. The jack 101 includes a body 103 supported on wheels 105. The body 103 houses a hydraulic pump/actuator assembly 107 having a pump rod 107a operatively engaged by a handle 109 and an actuator rod 107b. For purposes of explaining the rapid lift jack 101, the hydraulic pump/actuator assembly 107 will be assumed to be identical to the assembly 7 of the prior art jack 1 and therefore to have the same capacities, output forces, lengths of travel, etc. Manual pumping of the handle 109 cycles the pump rod 107a and produces hydraulic pressure which causes the actuator rod 107b to extend. The jack 101 further includes an elongate lift arm 111 having a proximate end 113 and a distal end 115. Unlike the lift arm 11 of the jack 1, the lift arm 111 is not triangular in shape but has a generally uniform cross-section. The lift arm 111 is pivotally connected to the body 103 by a first pivot pin 117 located adjacent to the proximate end 113.

A saddle 121 is pivotally connected to the distal end 115 of the lift arm 111 by a saddle pivot pin 123. The saddle 121 includes an abutment feature 125 for engaging the underside of an object to be raised, such as a vehicle or component of a vehicle. A pair of stabilizer links 127 each have a first end pivotally connected to the saddle 121 and a second end pivotally connected to the body 103. The stabilizer links 127 act to keep the abutment feature 125 of the saddle 121 in a generally horizontal orientation throughout the range of movement of the lift arm 111.

A significant difference between the rapid lift jack 101 and the prior art jack 1 is the inclusion of a power arm 129 in the jack 101. The power arm 129 forms part of a linkage 131 between the actuator rod 107b of the hydraulic pump/actuator assembly 107 and the lift arm 111 and causes the lift arm 111 to move upward a greater distance for each stroke of the handle 9, than does the lift arm 11 of the jack 1. The power arm 129 includes a first end 133, a second end 135, and is pivotally connected to the body 103 by a second pivot pin 137 positioned proximate the first end 133 of the power arm 129. The actuator rod 107b is pivotally connected to the power arm 129 by a third pivot pin 139 positioned at a point between the first end 133 and the second end 135 of the power arm 129. A connecting arm 141 has a proximate end 143 pivotally connected to the power arm 129 by a fourth pivot pin 145 positioned proximate the second end 135 of the power arm 129. A distal end 147 of the connecting arm 141 is pivotally connected to the lift arm 111 at a point somewhat inboard of its distal end 115 by a fifth pivot pin 149. The distance between the first pivot pin 117 and the fifth pivot pin 149 should be at least one half (½) of the distance between the first pivot pin 117 and the saddle pivot pin 123, and preferably at least two thirds (⅔) of the distance between the first pivot pin 117 and the saddle pivot pin 123. The distance between the first pivot pin 117 and the fifth pivot pin 149 should also be longer than the distance between the second pivot pin 137 and the fourth pivot pin 145.

The addition of the power arm 129 to the jack 101 creates two moment arms through which torque is transferred from the pump/actuator assembly 107 to the lift arm 111: an input moment arm B through which the actuator rod 107b acts on the power arm 129 and an output moment arm C through which the power arm 129 acts on the lift arm 111 through the connecting arm 141. The input moment arm B is defined by the distance between a central axis of the second pivot pin 137 and a central axis of the third pivot pin 139. The output moment arm C is defined by the distance between the central axis of the second pivot pin 137 and a central axis of the fourth pivot pin 145. It should be noted that the output moment arm C is preferably longer than the input moment arm B. The difference in length between the shorter input moment arm B and the longer output moment arm C results in an increase in the distance traveled by the lift arm 111 for each pump of the handle 109 over the design of the jack 1, wherein the input moment arm and the output moment arm were the same (the distance A). The central axes of the pivot pins 117, 137, 139, 145 and 149 all define pivot points for the respective parts of the linkage 131.

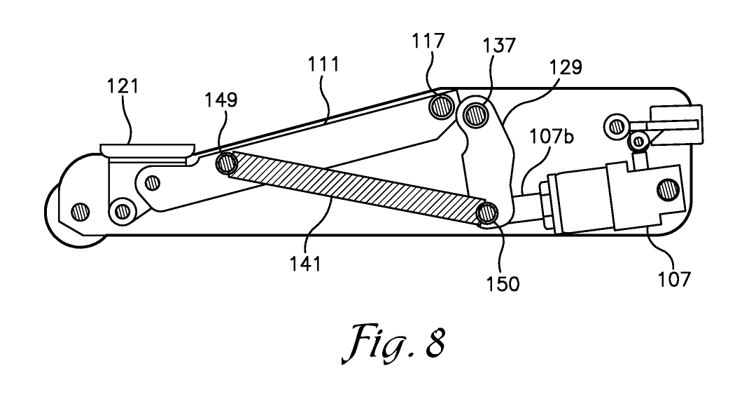

Although there are advantages to having an input moment arm B that is of a shorter length than the output moment arm C, it is foreseen that in some applications it might be desirable for the input and output moment arms to have the same length, for example, FIG. 8 shows an alternative embodiment of the present invention wherein the actuator rod 107b and the connecting arm 141 are connected to the power arm 129 by a single pivot pin 150 which would serve as both the third pivot pin 139 and the fourth pivot pin 145.

Looking at the jack 101 in greater detail, the body 103 includes a pair of spaced apart side plates 155. Each side plate 155 has a forward portion 157 which tapers downwardly toward a forward end 159 of the body 103. Spacers 161 are positioned between the side plates 155 and help to keep the side plates 155 in proper spaced apart relation. A top plate 163 is installed between the side plates 155 along top edges thereof rearward of the forward portions 157.

The wheels 105 include a pair of front wheels 105a rotatably mounted on an axle 167 which extends between the body side plates 155 proximate the forward end 159 of the body 103. The front wheels 105a are each positioned exterior to the respective side plate 155. The wheels 105 further include a pair of rear caster wheels 105b. The rear caster wheels 105b are each rotatably mounted in a respective yoke 169. Each yoke 169 is rotatably mounted to a respective stub arm 171 which extends laterally outward from a respective one of the side plates 155.

The hydraulic pump/actuator assembly 107 is mounted between the side plates 155 proximate a rearward end 173 of the body 103. The assembly 107 includes a pump body 175 and an actuator 177. A pump pivot pin 179 extends through aligned apertures in the pump body 175 and the side plates 155 to pivotally mount the pump/actuator assembly 107 within the body 103. The actuator rod 107b extends forwardly from the actuator 177 and includes an aperture formed near its forward end for receiving the third pivot pin 139. The pump rod 107a extends upwardly and rearwardly from the pump body 175 and terminates in a hook structure 181.

A handle mount 183 is pivotally mounted between the side plates 155 above the pump body 175 for rotation about a handle pivot pin 185. The handle mount 183 includes a socket 187 for receiving a lower end of the handle 109. A pump actuating pin 189 is secured to the handle mount 183 in a position radially offset from the handle pivot pin 185 and serves as an axle for a roller 191. The pump actuating pin 189 and its roller 191 are received within the hook structure 181 of the pump rod 107a. As the handle 109 is cycled up and down, the handle mount 183 is rotated about the handle pivot pin 185 and the motion is transferred to the pump actuating pin 189. The pump actuating pin 189 engages the hook structure 181 of the pump rod 107a through the roller 191 and moves the pump rod 107a in and out, thereby building hydraulic pressure in the pump body 175. The pressurized hydraulic fluid flows into the actuator 177, causing the actuator rod 107b to extend.

The lift arm 111 includes a pair of spaced apart longitudinal beams 193 interconnected by one or more spacers 195. A sleeve 197 is secured to longitudinal beams 193 at the proximate end 113 of the lift arm 111 and serves as a receiver for the first pivot pin 117, which is inserted through the sleeve 197 and a pair of aligned apertures in the side plates 155. A lift arm top plate 199 is secured to upper edges of the beams 193 and generally extends across the gap between the side plates 155 of the body 103. A pair of aligned apertures formed through the beams 193 proximate the distal end 115 of the lift arm 111 receive the saddle pivot pin 123 which attaches the saddle 121 to the lift arm 111. Another pair of aligned apertures formed through the beams 193 receive the fifth pivot pin 149.

The saddle 121 includes a crosspiece 201 and a pair of depending ears 203. The ears 203 have two pairs of aligned openings formed therethrough, one pair receiving the saddle pivot pin 123 and the other pair receiving a stabilizer pivot pin 205 which attaches the first ends of the stabilizer links 127 to the saddle 121. The distal end 115 of the lift arm 111 fits between the ears 203 of the saddle 121 and the saddle pivot pin 123 is inserted through the respective apertures formed in the ears 203 and beams 193.

The abutment feature 125 is shown as comprising an upper surface of a circular abutment member 207. A depending post 209 on the abutment member 207 extends downwardly through a center opening formed in the crosspiece 201 of the saddle 121 and rotatably attaches the abutment member 207 to the crosspiece 201. It is to be understood, however, that the saddle 121 and/or abutment member 207 can be made in a variety of shapes depending on the particular application, and it is foreseen that the abutment feature 125 may be shaped to fit or connect to receiving structures on the object to be lifted, such as slots, grooves, notches, posts, flanges or a wide range of other features or contours on various surfaces. It is also foreseen that the saddle 121 and abutment member 207 may be integrally formed instead of being separate connected pieces.

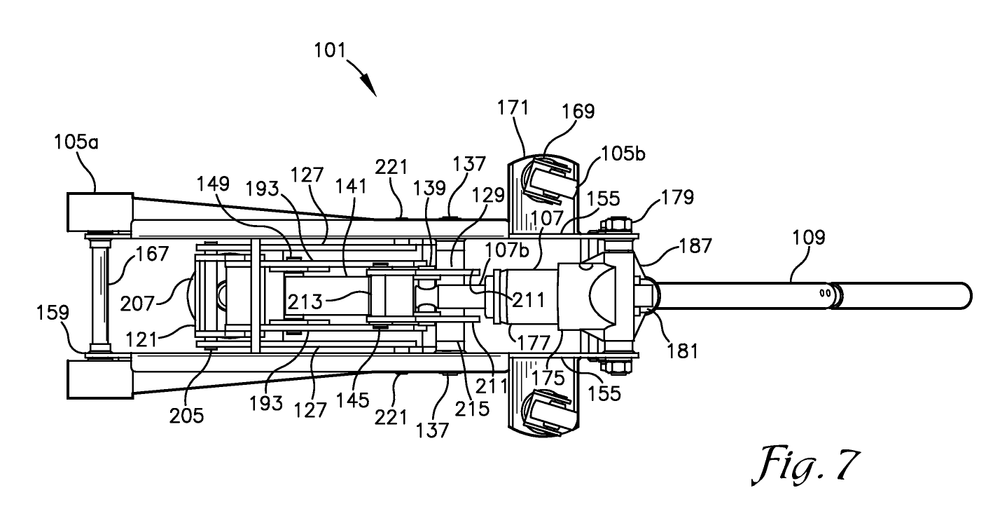

As best seen in FIG. 7, the power arm 129 includes a pair of spaced apart plates 211 interconnected by spacers 213. A sleeve 215 is secured to both plates 211 and serves as a receiver for the second pivot pin 137, which is inserted through the sleeve 215 and a pair of aligned apertures in the side plates 155. Two sets of aligned apertures in the side plates 211 form receivers for the third pivot pin 139 and fourth pivot pin 145. The end of the actuator rod 107b is received between the plates 211 and the third pivot pin 139 is received through the aperture formed in the actuator rod 107b and the respective apertures in the plates 211.

The connecting arm 141 is formed of rectangular tubing and has a first sleeve 217 secured to its proximate end 143 and a second sleeve 219 secured to its distal end 147. The first sleeve 217 serves as a receiver for the fourth pivot pin 145. The second sleeve 219 serves as a receiver for the fifth pivot pin 149. The proximate end 143 of the connecting arm 141 fits between the plates 211 of the power arm 129 and the fourth pivot pin 145 is inserted through the first sleeve 217 and the respective apertures in the plates 211. The distal end 147 of the connecting arm 141 fits between the beams 193 of the lift arm 111 and the fifth pivot pin 149 is inserted through the second sleeve 219 and the respective apertures in the beams 193.

The stabilizer links 127 each comprise a piece of generally flat stock having an aperture formed therethrough proximate each of the first and second ends. The first ends of the stabilizer links 127 are positioned outside of the ears 203 of the saddle 121 and are pivotally connected to the saddle 121 by the stabilizer pivot pin 205 which extends through the respective apertures in the stabilizer links 127 and ears 203 of the saddle 121. The second ends of the stabilizer links 127 are pivotally connected to the side plates 155 of the body 103 by respective short pivot pins 221. Each short pivot pin 221 is inserted through the respective aperture in the respective stabilizer link 127 and through an associated aperture formed through the respective side plate 155.

In use, the rapid lift jack 101 is rolled under the object to be raised and the abutment feature 125 is aligned with any suitable structure on the underside of the object for receiving an upward force to lift the object. A human operator begins pumping the handle 109 up and down, causing the pump portion of the hydraulic pump/actuator assembly 107 to build hydraulic pressure. As pressure builds, the actuator rod 107b begins to extend and applies a force F to the power arm 129 through the third pivot pin 139. Since the power arm 129 is connected to the body 103 by the second pivot pin 137, the force F creates a torque acting on the power arm 129 through the input moment arm defined by the distance B between the second pivot pin 137 and the third pivot pin 139. The torque causes the power arm 129 to begin to rotate about the second pivot pin 137, and is transferred to the connecting arm 141 through the longer output moment arm defined by the distance C between the second pivot pin 137 and the fourth pivot pin 145. The connecting arm 141 transfers the motion of the power arm 129 at the fourth pivot pin 145 to the lift arm 111. As the power arm 129 moves, the fourth pivot pin 145 moves a greater distance for each pump of the handle 109 than does the third pivot pin 139 due to the longer moment arm. The power arm 129, therefore, acts to increase, multiply or magnify the distance traveled by the lift arm 111 for each stroke of the handle 109.

As the handle 109 is pumped, the lift arm 111 rotates upwardly under the urging of the connecting arm 141, which in turn moves the saddle 121 upwardly. The lift arm 111 continues to move upwardly and brings the abutment feature 125 into contact with the underside of the object to be raised. Continued pumping of the handle 109 after contact of the abutment feature 125 with the object will begin to raise the object. Since the lift arm 111 is moving further for each stroke of the handle 109 than the prior art jack 1 did for each stroke of the handle 9, the object will be lifted faster than was possible with the prior art jack 1.

It is to be understood that while certain forms of the present invention have been illustrated and described herein, it is not to be limited to the specific forms or arrangement of parts described and shown. As used in the claims, identification of an element with an indefinite article “a” or “an” or the phrase “at least one” is intended to cover any device assembly including one or more of the elements at issue. Similarly, references to first and second elements, or to a pair of elements, is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed and desired to be secured by Letters Patent is as follows:

1. In a lifting device having a body, a lift arm pivotally connected to the body at a first pivot point and an actuator mounted to the body, the actuator having an actuator rod which extends upon operation of the actuator, a linkage between the actuator rod and the lift arm comprising:
a) a power arm pivotally attached to the body at a second pivot point and pivotally connected to the actuator rod at a third pivot point spaced at a first distance from said second pivot point; and
b) a connecting arm having a proximate end pivotally attached to said power arm and a distal end pivotally attached to the lift arm.

2. The linkage as in claim 1 wherein said proximate end of said connecting arm is connected to said power arm at a fourth pivot point spaced at a second distance from said second pivot point; and said second distance is greater than said first distance.

3. The linkage as in claim 2 wherein said power arm has first and second ends, said second pivot point is proximate said first end of said power arm, said fourth pivot point is proximate said second end of said power arm and said third pivot point is between said first and second ends of said power arm.

4. The linkage as in claim 2 for use with a lifting device having a saddle pivotally attached to the lift arm at a saddle pivot point and wherein said distal end of said connecting arm is pivotally connected to the lift arm at a fifth pivot point located on the lift arm at a distance from the first pivot point which is at least one half of the distance from the first pivot point to the saddle pivot point.

5. The linkage as in claim 4 wherein said distance from said first pivot point to said fifth pivot point is at least two thirds of the distance from the first pivot point to the saddle pivot point.

6. The linkage as in claim 4 wherein said distance from said first pivot point to said fifth pivot point is greater than said second distance.

7. The linkage as in claim 1 wherein said proximate end of said connecting arm is connected to said power arm at said third pivot point.

8. A lifting device comprising:
a) a body;
b) a lift arm pivotally connected to said body at a first pivot point;
c) an actuator mounted to said body, the actuator having an actuator rod which extends upon operation of said actuator; and
d) a linkage between said actuator rod and said lift arm, said linkage comprising:
i) a power arm pivotally attached to said body at a second pivot point and pivotally connected to said actuator rod at a third pivot point spaced at a first distance from said first pivot point; and
ii) a connecting arm having a proximate end pivotally attached to said power arm and a distal end pivotally attached to the lift arm.

9. The lifting device as in claim 8 wherein said proximate end of said connecting arm is connected to said power arm at a fourth pivot point spaced at a second distance from said second pivot point; and said second distance is greater than said first distance.

10. The lifting device as in claim 9 wherein said power arm has first and second ends, said second pivot point is proximate said first end of said power arm, said fourth pivot point is proximate said second end of said power arm and said third pivot point is between said first and second ends of said power arm.

11. The lifting device as in claim 8 wherein:
a) said lift arm includes proximate and distal ends, said first pivot point is at said proximate end;
b) said lifting device further includes a saddle pivotally connected to said distal end of said lift arm at a saddle pivot point; and wherein
c) said distal end of said connecting arm is pivotally connected to said lift arm at a fifth pivot point located on said lift arm at a distance from the first pivot point which is at least one half of the distance from the first pivot point to said saddle pivot point.

12. The lifting device as in claim 11 wherein said distance from said first pivot point to said fifth pivot point is at least two thirds of the distance from the first pivot point to the saddle pivot point.

13. The lifting device as in claim 11 wherein:
a) said saddle includes an abutment feature for abutting the underside of an object to be lifted; and
b) at least one stabilizer arm connected between said saddle and said body and operates to keep said abutment feature horizontal throughout a range of movement of said lift arm.

14. The lifting device as in claim 11 wherein said distance from said first pivot point to said fifth pivot point is greater than said second distance.

15. The lifting device as in claim 8 wherein said proximate end of said connecting arm is connected to said power arm at said third pivot point.

16. The lifting device as in claim 8 wherein said actuator is part of a hydraulic pump/actuator assembly manually operable using a pump handle.

17. A floor jack comprising:
a) a body mounted on wheels;
b) a lift arm having proximate and distal ends, said proximate end pivotally connected to said body at a first pivot point;
c) a saddle pivotally connected to said distal end of said lift arm and including an abutment feature for abutting the underside of an object to be lifted;
d) at least one stabilizer arm connected between said saddle and said body and operating to keep said abutment feature in a desired orientation throughout a range of movement of said lift arm;
e) a pump/actuator assembly manually operable using a pump handle and having an actuator rod that extends upon operation of said pump/actuator assembly;
f) a connecting arm having proximate and distal ends, said distal end pivotally connected to said lift arm; and
g) a power arm pivotally attached to the body at a second pivot point, pivotally connected to the actuator rod at a third pivot point spaced at a first distance from said second pivot point; and pivotally attached to said proximate end of said connecting arm.

18. The floor jack as in claim 17 wherein said proximate end of said connecting arm is connected to said power arm at a fourth pivot point spaced at a second distance from said second pivot point; and said second distance is greater than said first distance.

19. The floor jack as in claim 18 wherein said power arm has first and second ends, said second pivot point is proximate said first end of said power arm, said fourth pivot point is proximate said second end of said power arm and said third pivot point is between said first and second ends of said power arm.

20. The floor jack as in claim 18 wherein:
a) said saddle is pivotally connected to said distal end of said lift arm at a saddle pivot point; and
b) said distal end of said connecting arm is pivotally connected to said lift arm at a fifth pivot point located on said lift arm at a distance from the first pivot point which is at least one half of the distance from the first pivot point to said saddle pivot point.

21. The floor jack as in claim 20 wherein said distance from said first pivot point to said fifth pivot point is at least two thirds of the distance from the first pivot point to the saddle pivot point.

22. The floor jack as in claim 18 wherein said distance from said first pivot point to said fifth pivot point is greater than said second distance.

23. The floor jack as in claim 17 wherein said proximate end of said connecting arm is connected to said power arm at said third pivot point.
